(19) United States
(12) Patent Application Publication
(10) Pub. No.: US 2011/0032265 A1
(43) Pub. Date: Feb. 10, 2011

(54) Pipelined computing device for connecting contour elements from image data

(75) Inventors: Sebastian Weng, Radeberg (DE); Sebastian Siegel, Dresden (DE); Martin Franz, Dresden (DE); Stefan Noke, Dresden (DE); Joachim Ihlefeld, Dresden (DE)

Correspondence Address: DeMont & Breyer, LLC, 100 Commons Way, Ste. 250, Holmdel, NJ, 07733, US

(73) Assignee: BAUMER INNOTEC AG, Frauenfeld (CH)

(21) Appl. No.: 12/696,273

(22) Filed: Jan. 29, 2010

(30) Foreign Application Priority Data
Jan. 29, 2009 (DE) 10 2009 006 660.8

(51) Int. Cl. G09G 5/00

(52) U.S. Cl. 345/581

(57) ABSTRACT

A pipelined computing device is provided that is designed i) to generate a list of coordinates of starting points and endpoints of chains and to store these in a memory, ii) for each starting point and endpoint, to search the list of coordinates of starting points and endpoints for the last occurrence of the same coordinates or coordinates lying within a neighborhood of a specified size, and iii) to allocate to each starting point or endpoint a vertex index and an instance index, wherein the vertex index is a running index of vertices and the instance index represents a running index of the starting points and endpoints belonging to a vertex, wherein associated points from the set of starting points and endpoints receive the same vertex index and are those points that have the same coordinates or coordinates that lie within the neighborhood of a specified size.

### CROSS-REFERENCE TO RELATED APPLICATIONS

The German patent application DE 10 2009 006 660.8, filed Jan. 29, 2009, is incorporated herein by reference.

### FIELD OF THE INVENTION

The invention relates, in general, to image processing. In particular, the invention relates to the processing of contours in image data, with short contours being linked to form longer contours.

### BACKGROUND OF THE INVENTION

It is known with pipelined processors to process image data in hardware in real time generally so that attributed contour elements (chains) are generated with sub-pixel resolution. Such a method and a corresponding image processing device are disclosed in DE 10 2006 044 595 A1.

Determining contour points themselves with sub-pixel resolution is also described in WO 2005/073911 A1.

Due to the pattern comparisons of the gray-scale value or color distributions performed for determining the contour point with, as a rule, 5×5 or larger convolvers, the resolution of this method remains limited in view of the Nyquist criteria. For the use of composite methods that process, in addition to high contrasts, also in a smaller, e.g., 3×3 environment, the resolution can be increased, but artifacts are simultaneously created that prevent the creation of long contours and that burden the resources of the system.

A generally automated recognition of objects is advantageously realized by means of their contours. In particular, the recognition of closed or approximately closed contours (blobs) is relevant here, because these objects are easily found in images and can be easily classified with reference to the features of surface area, extent, color values, etc. Other models consist of searching for long contours, e.g., lines, circle segments, etc. and comparing them with models.

Due to interference variables, such as, for example, image noise, contour images have artifacts (e.g., short breaks, branches, small circles in contours). Then, in general, at first many short contour segments are created that negatively affect the creation of long contours and that cannot be immediately recognized.

The problem arises to connect (link) these contour segments. For this purpose, a graph is generated. The nodes of the graph are linked with the contour segments, just like the contour segments with the nodes (vertices) of the graph.

At VGA resolution, often several 1000 s of contour segments are found in an image, with these segments needing a data structure in the MB range. Then the matching starting points and endpoints must be assembled by a sorting algorithm (node search), and then the graph is generated.

Such an algorithm requires a computer architecture with an external memory that generates high energy consumption due to its BUS width. Furthermore, an unnecessarily long computing time, lying in the range of a few 10 s to 100 ms on a standard PC at VGA resolution, is required by the sequential sorting algorithm. Accordingly, for integration in sensors suitable for industrial use, due to the design for the image processing, often an electrical power of only a few 100 milliwatts up to watts is available. Furthermore, it would be desirable that contours including the graph are available immediately after completion of the image transmission for further processing, so the device used for linking chains is capable of real-time processing.

The technical problem thus arises of creating a computing device that shortens the computing time relative to a PC by a factor of 10-100, reduces the loss power by a factor of 10-100 and reduces the structural size by a minimum of one order of magnitude.

### SUMMARY OF THE INVENTION

This technical problem is realized according to the invention with complete hardware integration, in particular, within a circuit, such as, for example, an FPGA or Gate Array. To solve this technical problem, methods (algorithms) are modified relative to known state of the art, in order to be able to be implemented in integrated circuits in contrast with known methods.

For efficient integration, in particular, global memory accesses are avoided and structures with advantageously local memories are used. Accompanying this is that only limited local information is used to connect chains to each other.

In other words, one problem of the invention now arises in that the chains are assembled into larger units or contours with the smallest possible memory requirements and computational expense, so that long contour segments are created that can be used directly for the quick searching of objects. The low memory requirements and the low computational expense here allow the integration of the process in the form of hardware. Thus a software-based integration on a memory-programmable computer can be avoided.

Accordingly, the invention provides a pipelined computing device for connecting contour elements from image data, wherein this device has at least one pipelined processor device. The pipelined processor device is designed
in a first process, to generate a list of coordinates of the starting points and endpoints of chains and to store this in a memory,
in a second process, for each starting point and endpoint, to search the list of coordinates of the starting points and endpoints for the last occurrence of the same coordinates or coordinates lying within a neighborhood of a specified size,
and, in a third process, allocates to each starting point or endpoint, a vertex index and an instance index, wherein the vertex index represents a running index of vertices and the instance index is a running index of the starting points and endpoints belonging to a vertex, wherein associated points from the set of starting points and endpoints receive the same vertex index and wherein associated points are those points from the set of starting points and endpoints that have the same coordinates or coordinates lying within a neighborhood of a specified size.

The invention also relates to a method for connecting contour elements from image data with which—advantageously on a pipelined computing device—a processing of the chain is performed by means of the three processes described above.

In these processes, the term “chain” designates a set of contour points belonging to a contour in an ordered sequence. Here an ordered sequence means that, for a diagram of the chain as a list including one list entry for a contour point, the contour points adjacent to this contour point are recorded in the preceding and subsequent list entry.

The chains themselves can be generated by an external image processing device. According to one improvement of the invention, however, the generation of chains in the form of ordered list data of contour points belonging to one contour is integrated into the device according to the invention in the form of a pipelined computing device. Hence, according to this improvement of the invention, a pipelined computing device pre-assigned to the computing device of the first process is provided as a component of the pipelined arrangement according to the invention, wherein this pre-assigned pipelined computing device is designed to determine contour points from image data and to output the contour points belonging to one contour as chains in the form of list data in which the contour points are listed in an ordered sequence according to their progression along the contour.

A vertex designates a node at which one or more chains have starting points or endpoints that are in common or that lie close to each other within a specified neighborhood.

With the end of the third process, a list is already provided in which are stored logical links of the shorter chains to longer units from associated chains. The processes as described above distinguish themselves in that they can be performed as a pipelined process with low memory expense, which allows, first, the implementation in a pipelined architecture. Here it is useful to allow the first, second, and third processes to process the appropriate data offset in time, but to carry out in parallel continuously in time. The use of a pipelined computing device therefore brings special advantages, because such computing devices make available very high data processing rates and thus allow, among other things, generally data processing of video image data in real time. Because the pipelined processing can be carried out continuously, in one improvement of the invention, it is provided that chains are fed to the first process continuously and the first, second, and third processes are executed simultaneously. Because the processes build on each other, however, here the processes are started one after the other. Obviously, however, it is also possible to implement the processes on a different kind of computer architecture, for example, on a desktop computer or to be applied to data of chains not generated continuously.

The pipelined computing device is assembled in an especially preferred way under the use of one or more FGGA or ASIC modules. The processes are consequently programmed according to the hardware into the modules. Because the contour or chain processing according to the invention requires only a few simple computing steps, a simple implementation on FPGA or ASIC modules is possible. Executing the processes on such processors offers, at least currently, a factor increase in computing speed compared with a memory-programmable processor and allows a compact and economical construction.

After the three processes, logical links of the chains are indeed created, but the information is still distributed across the list. Therefore there are advantages in sorting the data even more and creating a data structure in which the associated chains and their connections can be read directly. For this purpose, in one improvement of the invention, the pipelined computing device is designed, in a fourth process, to record the vertex and instance indices of every two starting points and endpoints that are in opposition with respect to the ends of a chain in a vertex structure together with the index of the connecting chain. The vertex structure represents, on its side, in turn, a list that is stored in a memory. The entry of the starting points or endpoints in opposition in this list is also called inverse linking below. With reference to the inverse linking, it can now be read directly, in the list or vertex structure, which vertices—one or more according to the profile of the contours of the image—are in connection with a certain vertex.

This inverse linking can be performed in a simple and quick way under the use of a double register. For this purpose, in an improvement of the invention it is provided that the pipelined computing device, in the third process, records information on the associated endpoint or starting point of the chain in opposition from the double register to a starting point or endpoint of a chain connected to a vertex. Here, a point or its information is recorded in a sub-register of the double register and the associated point in opposition or arranged on the other end of the chain is searched for and recorded in the other sub-register. By reading out the double register, associated starting points and endpoints are then assembled with their associated vertex indices.

To create the vertex structure, the fourth process can be improved by a writing process optimized for the vertex structure. In the case of this writing process, initially at least some, advantageously all, of the information for a vertex is assembled by a search process and buffered in a register set before the vertex is recorded in the vertex structure. In addition, information from the set of chains connected to a vertex is extracted and stored.

With the vertex structure, artifacts can then also be filtered out from the set of chains occurring in real time. The vertex structure has proven especially favorable, in order to be able to test the morphology of the contours for artifacts and to eliminate such artifacts.

One kind of frequently occurring artifact is a small circle. A circle in a graph designates a sequence of nodes (vertices) Kᵢ with the property that the successive nodes Kᵢ and Kᵢ₊₁ are connected with an edge (chain), the starting nodes and ending nodes are identical and all other nodes are paired disjointly. In such a circle, either the starting point and endpoint may be identical or a circle may be assembled from short chains that have common starting points and endpoints. In order to filter out such circles, the pipelined computing device is designed, in one improvement of the invention, in the fourth process, to store information from the set of chains connected to a vertex in the form of the length of the chains and their starting points or endpoints of the chains standing in opposition relative to the vertex in the vertex structure, wherein the pipelined computing device is also designed, for each vertex, to test whether its vertex index is identical to the vertex index of the starting point or endpoint in opposition and whether the length of the associated chain lies underneath a specified value, wherein, in the case that these conditions are satisfied, the rank of the vertex is decremented by two, and the list entry of the connection with the identical vertex index and vertex index of the starting point or endpoint in opposition is deleted.

In the case of this improvement of the invention, circles are eliminated that have a common starting point and endpoint. From this point, because the circle can be passed through from the vertex in two different directions—in the clockwise or counterclockwise direction, such a circle increases the rank of the associated vertex by two. Therefore, the rank is decremented by two in the filtering of the circle.

According to another alternative, or, in particular, additional improvement of the invention, the pipelined computing device is also designed, in the fourth process, to store information from the set of chains connected to a vertex in the form of the length of the chains and their starting points or endpoints of the chains standing in opposition relative to the vertex in the vertex structure. In addition, the pipelined computing device is designed to test, for each vertex, whether at least two of the connections belonging to a vertex have the same vertex index of the starting point or endpoint in opposition or whether, at the vertex in opposition, another connection exists whose vertex index is identical with the vertex index in opposition and whether the length of the chain corresponding to the connections is shorter than a specified value. In the case that these conditions apply, one of the two list entries of the connections is deleted or both entries are deleted and a new connection is generated and recorded. In both cases, the rank of the vertex is decremented by one.

In this improvement of the invention, circles that are assembled from two short chains that have common starting points and endpoints are identified and each replaced by a single path that connects the common starting points and endpoints. In this case, because only one of two connections extending from a vertex is deleted or the connections are replaced by a single connection, the rank of the vertex is decremented by only one.

A pipelined architecture that is especially effective for the type of data processing according to the invention can be implemented in that the pipelined computing device is equipped with two independent dual port RAM memories, wherein the pipelined computing device is also designed
to store the list generated in the first process of coordinates of starting points and endpoints of chains in a first dual port RAM memory and,
in the third process, to store a list with vertex indices and instance indices in the second dual port RAM memory.

This allows, among other things, simultaneous sorting of the data and the connection of chains into longer associated units, on one hand, by sorting the data in the first memory, and also simultaneous filtering of artifacts by evaluating the contents of the second memory, for example, an elimination of small circles as described above.

Furthermore, it is advantageous when the pipelined computing device also adds status information that marks the starting points and endpoints as not yet processed in the second process to the list generated in the first process of coordinates of the starting points and endpoints, and wherein, in the second process, a pointer to the list entries is incremented until a starting point or endpoint marked as not yet processed is reached, and wherein the coordinates of this point are then stored in a register and the list is then searched for points coinciding with this point, wherein the coordinates stored in the register are compared with the coordinates of the starting points and endpoints of the list. Such a procedure is favorable for guaranteeing that all of the starting points and endpoints are also processed. The marking can be performed, for example, by a mask bit.

According to the invention, the procedure also actually distinguishes whether it involves a starting point or endpoint. This differentiation can be performed just with the data of the chains input to the first process by means of a computing device connected in advance in the pipelined computing device according to the invention. Such a differentiation at first appears to be unnecessary, because a chain has no characterized direction. According to one improvement of the invention, therefore—advantageously before the first process—at least one bit is set that indicates whether the boundary points of a chain involve a starting point or endpoint of a chain. Because the differentiation between the starting point and endpoint is initially arbitrary, the starting points and endpoints may also be designated generally as an endpoint of a first type and an endpoint of a second type.

Finally, a chain represents a contour or a part of a contour that can be traversed in two directions. The differentiation is useful, however, because in this way a search of the data for points of a chain in opposition can be performed very effectively. For example, if the search is for the associated endpoint of a chain, it is already clear that none of the starting points are involved, because each chain has only one starting point and one endpoint.

In one improvement of the invention, the pipelined computing device is designed to assign and store at least one bit for distinguishing a starting point from an endpoint. The arbitrariness of the allocation, however, can be advantageously removed by performing the assignment as a starting point or endpoint of a chain according to specified rules. For example, the assignment may be advantageously performed with reference to the course of the color value or another attribute. The color value profile specifies a direction perpendicular to the profile of the chain or the contour. With the help of this direction, attributes can then be assigned uniquely, so that the direction of the color profile and the direction along the contour from the starting point to the endpoint are always right-handed or always left-handed relative to each other. In this way, the attribute of a starting point or endpoint advantageously contains additional information of the underlying image. Another, very simple possibility of allocation consists in assigning the attribute of starting points and endpoints simply with reference to the sequence of the list data of the chains.

### BRIEF DESCRIPTION OF THE DRAWINGS

The invention will be explained in more detail below using embodiments and with reference to the accompanying figures. Here, the same reference symbols refer to identical or similar elements.

Shown are:

FIG. 1 a chain shown as a progression of contour points and represented as a data structure,

FIG. 2A a vertex structure,

FIG. 2B different chains that are components of the vertex structure shown in FIG. 2A,

FIG. 3A a chain list,

FIG. 3B a compressed list generated from the chain list 104 with an index of the chains and additional bit information for the start and the end of the chains,

FIG. 3C another 109 that is generated from the list shown in FIG. 3B and that contains a vertex index and an instance index of vertices of the vertex structure shown in FIG. 2A,

FIG. 4 a diagram of a vertex structure generated from the list shown in FIG. 3C in list form,

FIGS. 5A and 5B two graph structures with small circles,

FIG. 6 a circuit diagram of a pipelined computing device,

FIG. 7A a picture of an embodiment in an industrial process,

FIG. 7B a cutout of the image shown in FIG. 7A,

FIG. 8A another picture of an embodiment in an industrial process, and

FIG. 8B a cutout of the picture shown in FIG. 8A.

### DETAILED DESCRIPTION

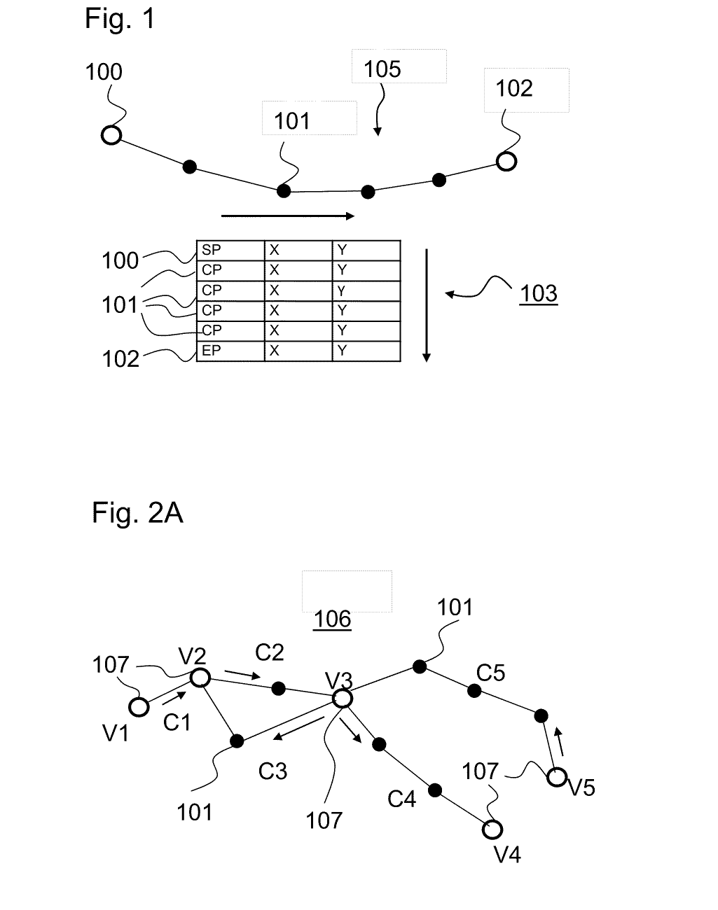

According to one embodiment of the invention, with one or more pipelined processors, image data are initially processed in hardware generally in real time, so that attributed contour elements (chains) are generated with sub-pixel resolution. A contour element or a chain 105 is shown in FIG. 1 and is, in this connection, the connection of a starting point (SP) 100 via a series of contour points (CP) 101 with an endpoint (EP) 102 and is stored by the pipelined architecture as an ordered sequence 103 of the coordinates of the involved points 100, 101, 102 in a memory.

For the object recognition, in general now a structure linked in two scanning directions of the contour elements is generated, wherein this structure is designated as a concatenated contour point list. Furthermore, adjacent contour elements concatenated via nodes or vertices are connected into a graph. These tasks require high computational power, especially in the case of fine contour resolution for general images, wherein this computational power shall be provided by an efficient pipelined processor.

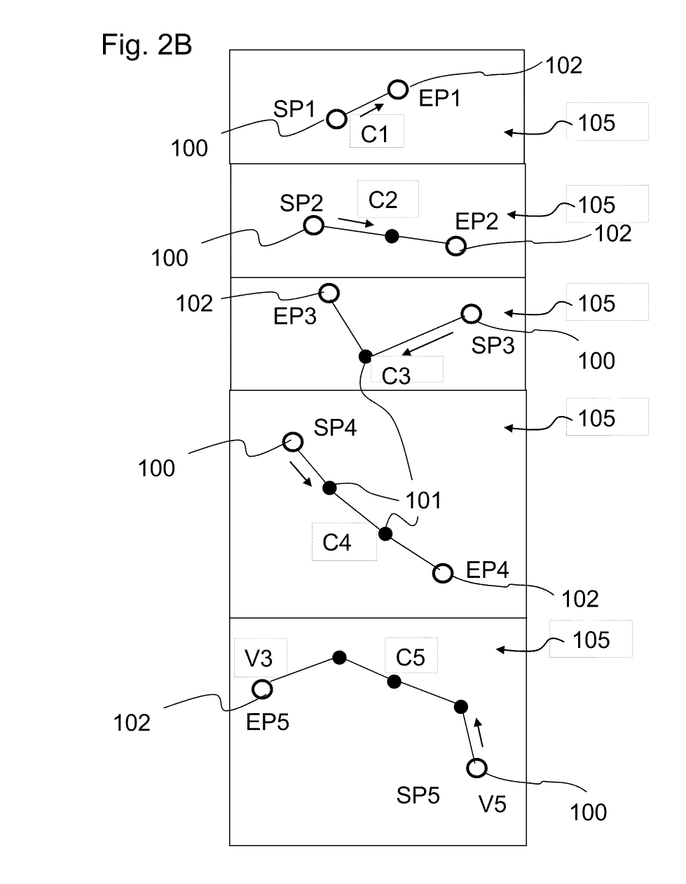

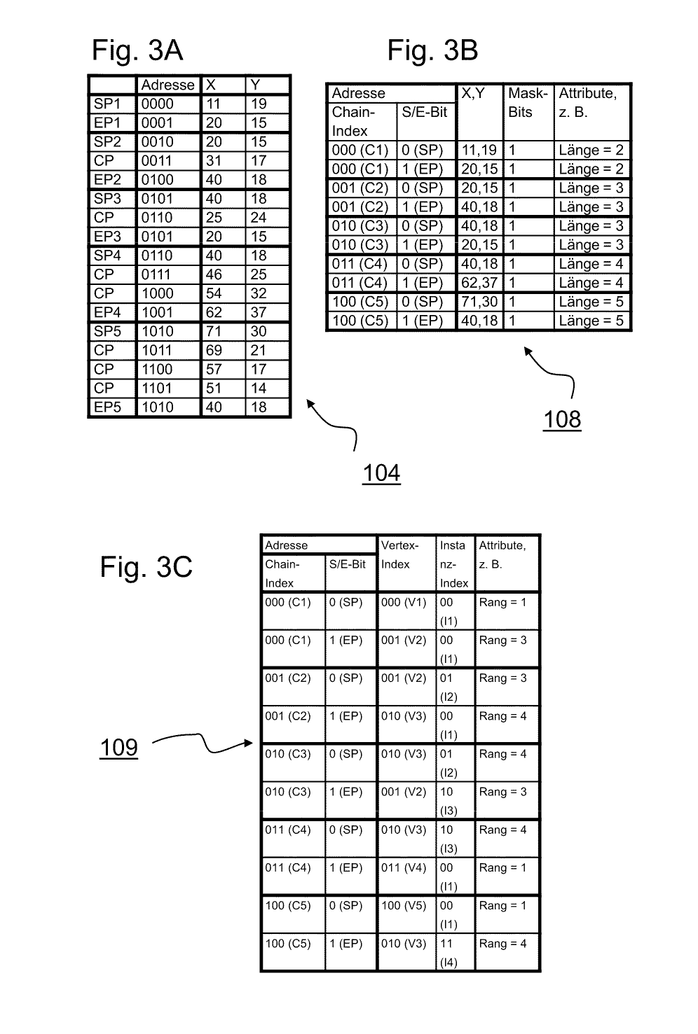

The formation of such a structure will be explained in greater detail with reference to FIGS. 2A, 2B and FIGS. 3A-3C.

When the chains are generated, artifacts appear due to noise or due to digitizing effects for the use of large convolver cores, wherein these artifacts prevent the creation of long contours and burden the resources of the system through an unnecessarily high number of small contour elements. Likewise, branching points of contours force the ending or beginning of one or more chains, because a chain cannot be uniquely continued at these points.

Due to the sequential character of the pipelined structure and the pseudo-random sequence in which the chains are generated, contours coinciding in the image can be distributed in the chain memory across several memory locations—in each case separated from each other by the data of other chains. This makes the tracing of long coinciding contours more difficult.

To obtain an efficient structure for the analysis of long chains, in a further pipelined process, a higher-ordered graph structure 106, as shown in FIG. 2A, is generated. The vertex structure shown in FIG. 2A has, as components, the chains 105 shown in FIG. 2B with starting points 100, endpoints 102, and—according to the length of the chain—optionally one or more other contour points 101. The vertices 107 of the structure shown in FIG. 2A are also indexed with an index V1, V2 . . . . Likewise, the starting points and endpoints 100, 102 are designated with indices SP1, SP2, . . . , SP5, and EP1, EP2, . . . , EP5, respectively. The chains 105 are numbered with indices C1, C2, . . . , C5. The associated vertex structure generated by the method according to the invention as a list in the memory contains those indices for the vertices and the starting points and endpoints and/or the chains, for example, in the form of running numbers.

For generating the graph structure 106, a list with attributed starting points and endpoints is generated that provides the connection information between the chains.

This information can then be used in subsequent processes to filter out artifacts or non-relevant structures from the detected contours (e.g., short, non-coherent contours with low contrast) from the relevant data and thus to allow real-time recognition of objects in the image data. From the filtered list of starting points and endpoints, the nodes (vertices 107) of a corrected graph are then generated.

The method that will be explained below with reference to the example lists of FIGS. 3A-3C is based on the facts that,
in a first process, a list of coordinates of the starting points and endpoints of chains is generated and stored in a memory,
and, in a second process, for each starting point and endpoint, the list of coordinates of starting points and endpoints is searched for the last occurrence of the same coordinates or coordinates lying within a neighborhood of a specified size,
and, in a third process, as a function of the search result of the second process, to each starting point or endpoint, a vertex index and an instance index are allocated, wherein the vertex index represents a running index of the vertices and the instance index is a running index of the starting points and endpoints belonging to a vertex, wherein associated points from the set of starting points and endpoints receive the same vertex index and wherein associated points are those points from the set of starting points and endpoints that have the same coordinates or coordinates that lie within a neighborhood of a specified size.

For this purpose, in a first process, starting points and endpoints are marked in an incoming chain list 104 provided as a data stream, as shown, for example, in FIG. 3A, and stored in a compressed list. FIG. 3B shows such a compressed list 108 created from the data of the list 104. The entries of this list are here addressed by the index of the chain and an additional bit information for the start and the end of the chain (2nd column of the list). The list 108 may be expanded by additional attributes, such as, e.g., the length (number of contour points) or the contrast of the chain, in order to filter the resulting data, in later processing, according to these criteria. Furthermore, status information for controlling further processes is inserted (mask bits). For example, each entry of the list is marked as “unprocessed.” For this purpose, a mask bit (4th column) is set to the value one in the case of the example shown in FIG. 3B.

In a second process, tuples of coinciding starting points or endpoints are then searched for in the list 108. Such points are coincident when the Euclidean distance between them is zero (type 0) or is non-zero and does not exceed a measure ε (type 1). Here, a tuple consists of a reference point and its neighbors. The points of one and the same tuple are distinguished by a counter (instance index). The tuples are indexed continuously by a counter (vertex index). After successful processing, a vertex of a graph is formed from each tuple.

At the beginning of the second process, advantageously first the next valid reference point is determined. For this purpose, in a simple way a pointer may be incremented until a new starting point or endpoint was found that was not yet allocated to a tuple and is thus designated as “unprocessed.” The instance index zero is allocated to this reference point and it is stored in a register.

Then the list 108 is searched for starting points or endpoints coinciding with the reference point. The coincident points of the tuple are buffered in a register set consisting of several registers. In addition, a running instance index and also the type of connection are stored. All of the points of the tuple are designated in the list 108 as “processed.” For this purpose, the mask bit can be switched in a simple way.

After the list 108 has been searched, a complete tuple that is fed to the third process described below is located in the register set. Then the second process begins again.

In a third process, the contents of the register set from the second process are recorded step for step in a list 109 shown as an example in FIG. 3C. The vertex index, the instance index, and also attributes (connection type, rank, and, if necessary, other parameters) are stored. Because the vertices and their relationship are stored in the list, this list represents a relationship between the shorter chains that are thus linked logically into larger coinciding contour segments and that represent, as list data, the graph structure 106 shown in FIG. 2A.

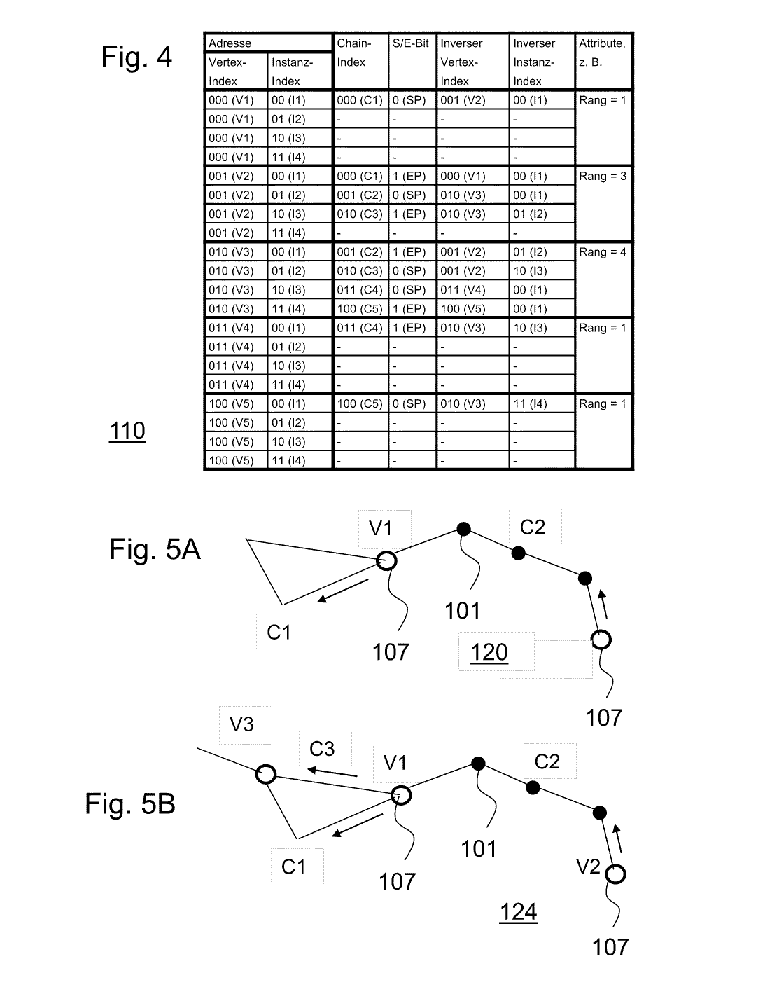

To be able to process the data more effectively, in a fourth process, the information is then read from the list 109 and stored in a vertex structure that can be addressed directly by means of the vertex index and the instance index according to the list 110 shown in FIG. 4 is stored in a not-shown third memory, e.g., in the main memory of a digital signal processor. For this purpose, the second memory is read continuously with an increasing address, so that the links to be allocated to the starting point and endpoint of a chain for the vertices appear one after the other on the output of the second memory.

Pi is defined as an address in the list 109 from which information is read. The vertex index recorded under Pi defines, in combination with the associated instance index, the address of the vertex structure (list 110) at which writing is performed. At this address, the following entries are written: chain index as well as starting/ending bit for distinguishing whether it involves a starting point or endpoint (Chain Index and also S/E Bit columns), vertex as well as instance index of the starting point or endpoint in opposition (Inverse Vertex Index as well as Inverse Instance Index columns).

If the start/end bit of Pi is set, then the information of the starting point or endpoint in opposition is at address Pi−1, or else it is at the address Pi+1. Furthermore, for each vertex, attributes (e.g., rank) are stored that can be expanded, optionally, by additional attributes of the individual instances of the vertex (e.g., connection type, length).

The resulting list 110 maintains the information of the searched graph structure 106 in an ordered sequence. For a vertex 107, the number of connections being used to other vertices 107 can be read and stored as the additional attribute, rank. In the example, it is assumed that for each vertex 107, a maximum of four instances can occur. Therefore, for each vertex, the structure 110 provides only four entries. Each connection is designated by a chain (Chain Index column) and a connected vertex (Inverse Vertex Index column). The Inverse Vertex Index column is used to be able to traverse the graph, because with its help it is made clear by means of which connection a vertex 107 has been reached.

Below, the function of a chain filter will be explained as an advantageous component of the pipelined computing device according to the invention.

This filter is based on the fact that the information stored in the fourth process in the list 110 representing the vertex structure was stored from the set of chains connected to a vertex 107 in the form of the length of the chains and their starting points or endpoints of the chains standing in opposition relative to the vertex in the vertex structure. For each vertex it is tested whether its vertex index is identical to the vertex index of the starting point or endpoint in opposition and whether the length of the associated chain lies below a specified value, wherein, in the case that these conditions are satisfied, the rank of the vertex is decremented by two and the list entry of the connection with the identical vertex index and vertex index of the starting point or endpoint in opposition is deleted.

For each vertex it is likewise tested whether at least two of the connections belonging to a vertex have the same vertex index of the starting point or endpoint in opposition or whether, at the vertex in opposition, another connection exists whose vertex index is identical with the vertex index in opposition and whether the length of the chains corresponding to the connections is shorter than a specified value, wherein, in the case that these conditions apply, one of the two list entries of the connections is deleted or both entries are deleted and a new connection is generated and recorded, wherein, in both cases, the rank of the vertex is decremented by one.

In this way, artifacts in the form of small circles are recognized and the graph structure is corrected while eliminating such circles. Two forms of small circles come into play:

a) Small circles in the graph, with these circles consisting of only one chain. One such small circle is shown in FIG. 5A as a component of the example graph structure 120. The chain designated with C1 is short and returns to the same point. Consequently, the starting point and endpoint are either identical or so close together that they are allocated to the same vertex 107.

b) Small circles that are made from two chains. One such small circle is shown in FIG. 5B as a component of the example graph structure 124. The chains C1 and C3 are short and have starting points and endpoints that are allocated to the same vertices 107.

The “small” attribute relates to the number of contour points of the chains that form the circle and/or the geometric length of the relevant chain. In order to decide whether the circles involve small circles, the information can be used whether the length of one chain is smaller than a given threshold. This information can be stored in the vertex list in the form of a status bit for each of the maximum of 4 connections belonging to a vertex. In the generation of the vertex structure, these status bits are calculated from the chain length stored in the list 108.

In order to detect small circles according to case a), the vertex structure is scanned corresponding to the list 110 shown in FIG. 4. Here, it is inspected, on one hand, whether the vertex index and the inverse vertex index are identical. On the other hand, it is checked whether the length of one chain is smaller than a given threshold, in that the status bit is evaluated. If both are fulfilled, then the entry is removed from the vertex structure and the rank of the current vertex is decremented by two. In this case, a second entry with the same chain still exists; this is also deleted. The remaining entries of the vertex in list 110 are shifted upward. Furthermore, the chain in list 104 is marked as deleted. In order to be able to process the data in this way, a random-access procedure is useful. Therefore, corresponding memories are favorably to be provided. If, in a running process, the list 110 is generated simultaneously, the use of, in particular, dual port RAM as the memory lends itself.

In order to recognize small circles according to case b), for each vertex 107 the connections are likewise scanned. A circle was recognized, if

i) at least two of the connections have the same inverse vertex index and the evaluation of the status bits of both connections shows that the length of the corresponding chain is smaller than a given threshold, or if,

ii) in the case of the inspection of the inverse vertex belonging to a connection it is determined that this has, on its side, a connection whose inverse vertex is identical to the current vertex and the evaluation of the status bits of both connections shows that the length of the corresponding chains is smaller than a given threshold.

In this case, one of the connections V from the vertex structure (list 110, FIG. 4) is deleted and the rank of the current vertex is decremented. The remaining entries of the vertex in the list 110 are then shifted upward.

Likewise, in the case of the inverse vertex, the same connection V is deleted, the rank is decremented, and the remaining entries of the vertex in the list 110 are shifted upward. Furthermore, the chain in the list 104 is marked as deleted. For this processing, a random access procedure to the data of the list 110 is also favorable.

In the following, hardware implementation is described for the pipelined computing device according to the invention suitable for the data processing described above.

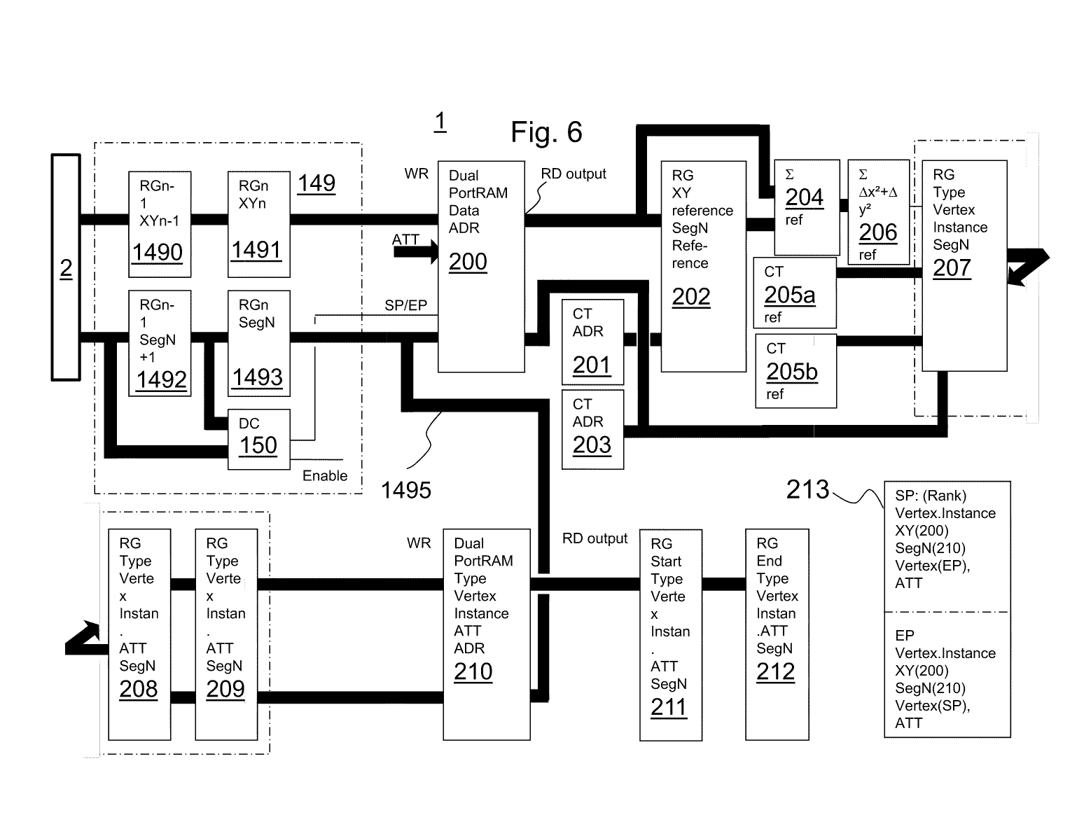

One embodiment of parts of such a pipelined computing device is shown in FIG. 6 as a schematic circuit diagram.

The pipelined computing device is based on the fact that starting points and endpoints of contour segments (chains) are stored in a fast dual port RAM 200. With a fast search process implemented in hardware, adjacent starting points and endpoints are assembled into nodes (vertices) and linked twice.

Through this architecture, new starting points and endpoints originating from an input data stream can be stored continuously and can be read without an additional time delay. A pipe will be defined with which the calculation of a distance measure is performed by means of a register 202 and adders 204, 206. In this way, the detection of adjacent counter segments is also supported in the case of interference. Furthermore, the issuing of the vertex indices (instances) is performed in the same process. The distance measure may be the Euclidean distance or also a different distance. For example, the determination of the Manhattan distance that is calculated for two points with the coordinates (x₁, y₁), (x₂, y₂) according to the relationship d((x₁, y₁), (x₂, y₂))=|x₁-x₂|+y₁-y₂| is also possible and very simple.

The part 149 of the pipelined computing device 1 represents an output interface for the first process in which a list of coordinates of the starting points and endpoints of chains is generated and stored in a memory. The part 149 comprises four registers 1490, 1491, 1492, 1493, and a decoder 150.

From a pipelined process or an upstream part 2 of the pipelined computing device, contour points linked into chains are output that are designated by a segment number SegN and by their coordinates as well as additional attributes ATT (such as, e.g., contrast or chain length). The creation of such contour points linked by chains is performed advantageously by means of a pipelined processor, as described in DE 10 2006 044 595 A1. These contour points linked into chains represent ordered contour point lists in which the contour points are listed one after the other according to their progression along a contour. The contour points are output beginning with the starting point SP in a running sequence up to the endpoint EP with a uniform segment index SegN or another designation of the segments.

The points of the lists are guided successively through the registers 1490, 1491 and, in parallel to this, the segment numbers are guided through the registers 1492, 1493, before they are stored in the dual port RAM 200.

The data appears at the output of the registers RGn XYn and RGn SegN of 1491, 1493, respectively. Then, whenever the segment index changes, if there is initially an endpoint, the directly adjacent data point is the starting point of the next contour. By comparing the segment indices in the decoder 150, the starting point and endpoint are recognized, so that these can be output to different addresses.

Thus, if the segment number changes, which is recognized by the decoder 150 with reference to a comparison of the contents of the registers 1492, 1493, then at this moment, due to the registers 1490, 1491 connected in series, the last point of the segment previously led through the part 149 is stored in register 1491 and the first point of the next segment is stored in register 1490. The decoder 150 can then designate these points as endpoints or starting points when writing in the dual port RAM.

The decoder 150 marks accordingly the starting points and endpoints of the chains (SP/EP). From the segment number SegN and the bit for marking the starting/endpoints, the address is formed in the dual port RAM 200; the XY coordinates of the starting/endpoints are recorded here.

Accordingly, in an improvement of the invention it is provided that the pipelined computing device 1 for carrying out the first process has two registers 1490, 1491 that are connected in series and through which the contour points are led successively, as well as two registers 1492, 1493 that are likewise connected in series and through which a designation of contour point segments allocated to the contour points is led in parallel (in this example, the segment number), wherein a decoder is provided that compares the contents of the series-connected registers 1492, 1493 and if the register contents are different, the contour points currently stored in the registers through which the contour points are successively led are designated as endpoints and starting points advantageously when writing into the memory 200. In this way, a list of starting points and endpoints in the memory 200 can be generated very easily in a pipelined process. The designation is advantageously performed, as described above, by setting a bit. The memory address is then given from the low part for designating the starting point or endpoint and from a high part consisting of the segment number shifted to the left by one bit. The memory region to be searched can be limited by not wiring higher address bits.

In the search procedure of the second process, for each starting point and endpoint, the list of coordinates of the starting points and endpoints is searched for the last occurrence of the same coordinates or coordinates lying within a neighborhood of a specified size, that is, within a distance. In the dual port RAM 200, through the first process, all of the starting points and endpoints required for the analysis of local neighborhoods are recorded. The first process here essentially follows the scanning direction of the image sensor, that is, the reading of the still short contour segments is performed in this way, so that contour elements adjacent in the data stream also essentially maintain their adjacency in the dual port RAM. This allows the use of a comparatively small dual port RAM.

A counter 201 forms the read pointer of the dual port RAM 200. It increments the last processed address until a previously non-processed starting/endpoint appears on the output “RD output” of the dual port RAM 200.

Segment number and XY coordinates are then stored as a new reference point in a register 202; simultaneously, the vertex counter 205a is incremented and the instance counter 205b is set to zero. Then the procedure switches from the counter 201 to a second counter 203 that runs through the entire search region with possibly adjacent starting points or endpoints and therefore generates, on the output RD output, a sequence of starting points and endpoints. With the counter 203 the dual port RAM 200 is scanned, the register 202 (reference memory) and the adders 204, 206 calculate a data stream with distance values. If a distance (e.g., the Euclidean distance) is less than a threshold 8, then it is assumed that the relevant starting points and endpoints belong to one node. In particular, in the case of the embodiment shown in FIG. 6 a reference point is selected and stored in register 202. The adders 204, 206 then calculate the distance of the reference point to the coordinate values of the stored points read during the scanning of the dual port RAM 200.

Advantageously, the Euclidean distance is calculated as a very precise distance measure. For this purpose, the adders 204 and 206 provide, together with a not-shown look-up table for squaring the coordinate differences Δx and Δy on the output of 206, the Euclidean distance between the reference point and the corresponding, incoming starting points and endpoints. If the Euclidean distance is less than a measure ε, then an instance counter 205b is incremented, and the instance, the segment index, and the vertex index, as well as the attributes ATT are stored in the register 207. If the coordinates are identical, the type is set to 0, otherwise to 1. The look-up table allows it to implement a non-linear distance calculation, such as, in particular, the calculation of the Euclidean distance with simple, very fast adders.

The counters 205a, 205b and the subsequent elements in the data stream in the pipelined computing device are used, among other things, for carrying out the third process in which a vertex index and an instance index are allocated to each starting point or endpoint, wherein associated points from the set of starting points and endpoints receive the same vertex index and wherein associated points are those points from the set of starting points and endpoints that have the same coordinates or coordinates lying within a neighborhood of a specified size.

One or more similar registers 208, 209 that together form a shift register are coupled to the register 207. The length of this shift register is equal to or greater than the number of connections going out from one vertex. By decoding, it is possible to determine the number of connections going out from a vertex (the rank).

The counters 205a, b and the register 207 form a structure, in order to generate a data stream with the entries of the relevant node (vertex). On the output of the register 207, the table according to FIG. 4 is produced in an ordered sequence. The registers 207-209 (and possibly other similar registers) are used accordingly for determining the rank, that is, the number of connections going out from or coming into a vertex. This list can then be transmitted to a processor and describes the graph, i.e., all connections going out from or coming into nodes.

With each shift cycle of the register 209, the information is written into the dual port RAM 210. In sync with the writing onto the dual port RAM 200, the dual port RAM 210 is read. The output data of the dual port RAM 210 are stored in a double register 211, 212, so that the complete information belonging to a chain also provides, in particular, the points in opposition with their vertex indices. This information that contains references from contour segments to nodes of the graph (double or inverse linking) is especially advantageous for the efficient tracking of cycles.

Therefore, in one improvement of the invention, the pipelined computing device is designed to store the nodes or vertices with their instances while interchanging data and addresses in the dual port RAM 210, in order to record, in the third process, information on the associated endpoint or starting point of the chain in opposition from the double register for a starting point or endpoint of a chain connected to a vertex.

The node index and the instance index are stored at the address of the index of the contour segment under inclusion of an address bit for the designation of the start and end. With a certain time interval, this memory can also be read. In a continuous sequence, it supplies the links of the contour segments to the allocated node instances.

An example configuration of the memory contents of the double register 211, 212 is designated with the reference symbols 213. The dashed separating line illustrates the partitioning of the contents to the registers 211, 212. Consequently, in the register 211, data of the starting point (“SP”) are stored. These are, advantageously, the rank of the associated vertex (“Rank”), the vertex instance (“Vertex.Instance”), the coordinates of the starting point (“XY”), the segment or chain number, with which the chains are numbered successively (“SegN”), the vertex index of the associated endpoint (“Vertex(EP)”) and additional attributes (“ATT”) are stored. In the register 212 for the associated endpoint (“EP”) in opposition, the vertex instance (“Vertex.Instance”), its coordinates (“XY”), the segment number (“SegN”), and the vertex index of the starting point (“Vertex(SP)”) are stored.

From the double register, the data are formatted so that the structure 109 is produced. This data stream is finally stored as a graph in the vertex structure 110. For this purpose, another memory not shown in FIG. 6 may be used.

As was already mentioned above, the dual port RAM 210 is read in sync with the writing to the dual port RAM 200. For this purpose, a dies 1495 from the address input of the dual port RAM 200 to the dual port RAM 210 is provided that causes synchronous addressing of both memories at a constant clock interval.

The synchronization of the processes in the pipelined computing device 1 is explained in even more detail below using an example. The contour segments or chains are input as stated on the input of the circuit according to FIG. 6 from part 2 as a continuous data stream with a running segment index. The following table gives an example for the data stream in the pipelined computing device 1 at the beginning of the processing:

| | Address | Wired | | | |
|---|---|---|---|---|---|
| Segment | Dual | Sub- | Starting/ | | |
| Index | Port RAM | address | Endpoint | RD output | Input |
| RGn SegN | 200, 210 | | | 210 | 200 |
| 0x007D | 0x00FB | 0x00FB | EP | void | 0x007D |
| 0x007E | 0x00FC | 0x00FC | SP | void | 0x007E |
| 0x007E | 0x00FD | 0x00FD | EP | void | 0x007E |
| 0x007F | 0x00FE | 0x00FE | SP | void | 0x007F |
| 0x007F | 0x00FF | 0x00FF | EP | void | 0x007F |
| 0x0080 | 0x0100 | 0x0000 | SP | SP 0x0000 | 0x0080 |
| 0x0080 | 0x0101 | 0x0001 | EP | EP 0x0000 | 0x0080 |
| 0x0081 | 0x0102 | 0x0002 | SP | SP 0x0001 | 0x0081 |
| 0x0081 | 0x0102 | 0x0002 | EP | EP 0x0001 | 0x0081 |

In the first column that corresponds to the output of the register RGn-SegN, reference symbol 1493, the segment indices are shown using example. For each starting point and endpoint, the same segment index is used. So that starting points and endpoints can now be distinguished, for example, the segment index is shifted to the left by one binary position and a bit SP/EP is added into the address. The corresponding addresses are listed in the second column of the table. This address is used for writing to the dual port RAM 200 and reading from the dual port RAM 210 in the same way.

Due to the sampling and segmenting method being used, the position of connected contour segments in the data stream is not arbitrary. For each starting point and endpoint, the associated starting points or endpoints of connected contour segments are arranged in the vicinity. This means that the difference of the segment indices of adjacent contour segments is limited to a constant size dependent on the system.

In the top example, for the sake of simplicity, it was assumed that the maximum index difference of adjacent contour segments is less than 128, thus, in hexadecimal notation, less than 0x0080. The search area can thus be limited to this size. If a larger area is needed due to the system, larger dual port RAMs 200, 210 with an expanded address range may be used.

The pipelined computing device now writes, at the beginning of each image, initially 128 starting points and 128 endpoints into the dual port RAM 200 up to the address 0x00FF. The search process runs during this time, but the output of the dual port RAM 210 is invalid (void). After recording the 128th starting/endpoint, all of the adjacent elements are stored in the dual port RAM 200, that is, consequently, also correctly in the dual port RAM 210.

Then the starting points and endpoints of the 129th contour segment are recorded at the address 0x0080 in the dual port RAM 200, the prior data are overwritten, because in this example the higher-value addresses are not wired. At the same address, the data for the contour element 0x0000 is made available on the output of the dual port RAM 210 as the first written contour element.

The registers 207, 208, 209 generate a delay, so that connection found as fast as possible for the new contour element at 0x0080 is written delayed into the dual port RAM 210 and data of the element 0x0000 is not overwritten ahead of time.

In the example, the pipelined processor uses a delay of 129 contour segments. After the image end or after processing all of the image data of an image, 129 additional cycles without input data are used to output the remaining data from the dual port RAM 210.

The addressing of the two dual port RAM's 200, 210 is thus performed according to the above example in sync with the same addresses that, however, actually refer to different starting points and endpoints or to different chains due to the delay of the processes and the limited address space.

With the architecture according to the invention, as was described, for example, with reference to FIG. 6, a pipelined processor for generating graphs from contour segments is provided that may be integrated into a circuit, such as, in particular, into an FPGA without additional external elements.

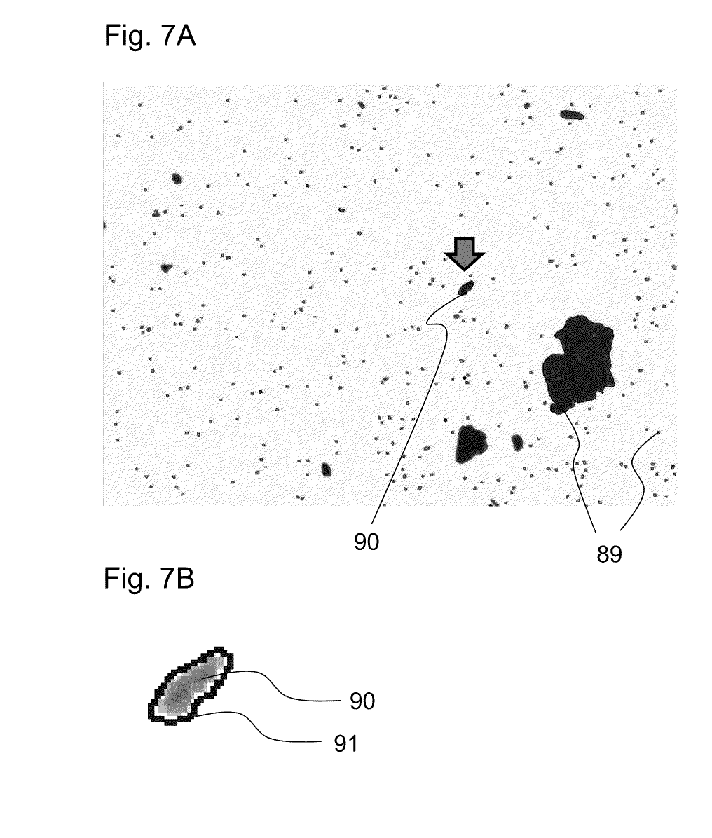

With reference to FIGS. 7A and 7B, an embodiment of the invention in an industrial process will be shown.

FIG. 7A shows an image taken with a camera of a particle stream of powder with particles 89, 90 of various sizes. With the images, under use of the pipelined computing device according to the invention, an automated particle analysis for the automatic control of cylinder mills in grinders is performed in real time. The particles are removed from the powder stream and blown through a channel at 20 m/s. Contours are determined with hardware; real-time capability is achieved at 50 images/s. The goal is a high-precision calculation of the surface-area distribution of the particles. For this purpose, the objects are divided into different classes, e.g., according to color or shape features and then surface-area histograms are calculated that are used instead of or in addition to sieve measurements previously created offline.

FIG. 7B shows enlarges the particle 90 designated in FIG. 7A with an arrow. By means of the pipelined computing device according to the invention, the contour segments defining the particle image were connected into a continuous, closed contour 91 in real time. This means that the closed contour 91 is available in the form of list data within a time period of the image capture period for all detected particles in the image. This contour 91 can now be used for determining the surface area of the particle 90.

In general, without limitation to the example shown in FIGS. 7A, 7B, the device may be used or constructed to determine closed contours of objects, in particular, for their identification and/or for determining the surface-area measure of the objects.

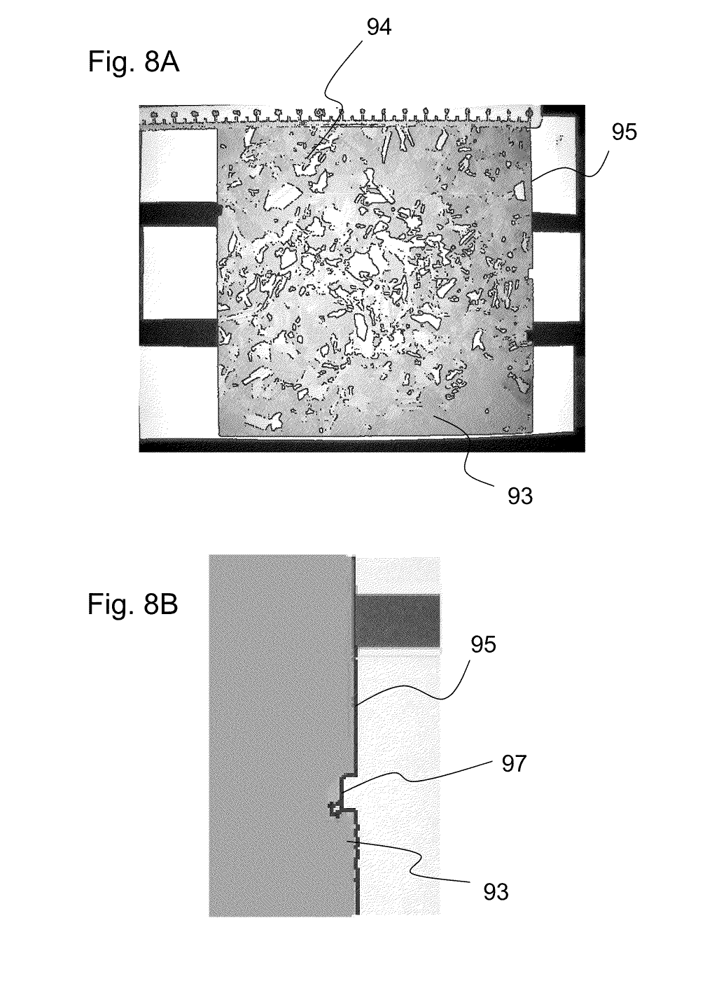

Below, with reference to FIGS. 8A and 8B, another embodiment in an industrial manufacturing process will be described. In particular, the pipelined computing device according to the invention may also be used for inspecting wafers.

FIG. 8A shows the image of a wafer 93. At first, all of the contours 94, 95 in the image are determined.

After the found contour segments had been linked into long contours by means of the pipelined computing device according to the invention, long contours may then be searched that are, in part, approximately line like. This may be performed, for example, in software through curvature analysis. FIG. 8A shows an image of the margin of the wafer. Also drawn is the long contour 95 remaining in this cutout due to the curvature analysis. As can be seen with reference to the image, this long contour 95 represents the margin of the wafer 93. As can be further seen, the contour also reproduces a break 97 at the margin of the wafer 93. With this it was shown that the outer outline of wafers or plates may be found by means of the invention independent of the background and may be represented in the form of long contours and thus also breaks may be found easily and reliably.

It is clear to those skilled in the art that a large number of other technical applications for the pipelined computing device according to the invention and for the method according to the invention exist from various fields of industrial applications.

It is clear to those skilled in the art that the invention is not limited to the example embodiments described above, but instead can be varied in various ways. In particular, the features of the individual embodiments may also be combined with each other. For example, the allocation of storage contents of the data structure 213 may also be distributed reversed to the two registers 211, 212.

1. Pipelined computing device for connecting contour elements from image data, comprising at least one pipelined processor device, which is designed,
in a first process, to generate a list of coordinates of starting points and endpoints of chains and to store the list of coordinates in a memory,
and, in a second process, for each starting point and endpoint, to search the list of coordinates of starting points and endpoints for the last occurrence of the same coordinates or coordinates lying within a neighborhood of a specified size,
and, in a third process, to assign to each starting point or endpoint a vertex index and an instance index, wherein the vertex index is a running index of vertices and the instance index represents a running index of the starting points and endpoints belonging to a vertex, wherein associated points from the set of starting points and endpoints receive the same vertex index and wherein associated points are those points from the set of starting points and endpoints that have the same coordinates or coordinates that lie within a neighborhood of a specified size.

2. Pipelined computing device according to claim 1, characterized in that the pipelined computing device is designed, in a fourth process, to record the vertex and instance indices of starting points and endpoints that are in opposition with respect to the ends of a chain in a vertex structure together with the index of the connecting chain.

3. Pipelined computing device according to claim 2, wherein the fourth process is designated by a writing process for the vertex structure in which at first at least some, advantageously all of the information for a vertex is assembled by a search process and buffered in a register set before the vertex is recorded in the vertex structure and that information from the set of chains connected to a vertex is extracted and stored.

4. Pipelined computing device according to claim 2, wherein the pipelined computing device is designed, in the fourth process, to store information from the set of chains connected to a vertex in the form of the length of chains and their starting points or endpoints of the chains standing in opposition relative to the vertex in the vertex structure, wherein the pipelined computing device is also designed to test, for each vertex, whether its vertex index is identical with the vertex index of the starting point or endpoint in opposition and whether the length of the associated chain lies below a specified value, wherein, in the case that these conditions are fulfilled, the rank of the vertex is decremented by two and the list entry of the connection with the identical vertex index and the vertex index of the starting point or endpoint in opposition is deleted.

5. Pipelined computing device according to claim 2, wherein the pipelined computing device is designed, in the fourth process, to store information from the set of chains connected to a vertex in the form of the length of the chains and their starting points or endpoints of the chains standing in opposition relative to the vertex in the vertex structure, wherein the pipelined computing device is also designed to test, for each vertex, whether at least two of the connections belonging to a vertex have the same vertex index of the starting point or endpoint in opposition or whether at the vertex in opposition another connection exists whose vertex index is identical with the vertex index in opposition and whether the length of the chains corresponding to the connections is shorter than a specified value, wherein, in the case that these conditions apply, one of the two list entries of the connections is deleted or both entries are deleted and a new connection is generated and recorded, wherein, in both cases, the rank of the vertex is decremented by one.

6. Pipelined computing device according to claim 1, wherein the pipelined computing device has two independent dual port RAM memories, wherein the pipelined computing device is designed
to store the list generated in the first process for coordinates of the starting points and endpoints of chains in a first dual port RAM memory and,
in the third process, to store a list with vertex indices and instance indices in the second dual port RAM memory.

7. Pipelined computing device according to claim 1, wherein the pipelined computing device is designed to also add status information that marks the starting points and endpoints as not yet processed in the second process in the list of coordinates of starting points and endpoints generated in the first process, and wherein, in the second process, a pointer to the list entries is incremented until a starting point or endpoint marked as not yet processed is reached, and wherein the coordinates of this point are then stored in a register, and the list is then searched for points coinciding with this point, wherein the coordinates stored in the register are compared with the coordinates of the starting points and endpoints of the list.

8. Pipelined computing device according to claim 1, wherein the pipelined computing device is designed to allocate at least one bit for distinguishing a starting point from an endpoint.

9. Pipelined computing device according to claim 1, characterized in that the pipelined computing device has, for carrying out the first process, two registers that are connected one after the other and by which the contour points are stepped through in succession, as well as two registers likewise connected one after the other by which a designation of contour point segments allocated to the contour points is stepped through in parallel, wherein a decoder is provided that compares the contents of the registers connected one after the other and, if the register contents are different, designates the contour points currently stored in the registers through which the contour points are stepped successively as endpoints and starting points advantageously during the storage in the memory.

10. Pipelined computing device according to claim 1, characterized by a pipelined computing device that is arranged in front of the computing device of the first process and that is designed to determine contour points from image data and to output the contour points belonging to a contour as chains in the form of list data in which the contour points are listed in ordered sequence according to their progression along the contour.

11. Pipelined computing device according to claim 1, characterized by having a double register, wherein the pipelined computing device is designed, in the third process, to record information for the associated endpoint or starting point of the chain in opposition from the double register for a starting point or endpoint of a chain connected to a vertex.

12. Pipelined computing device according to claim 11, which is designed to store the vertices with their instances while interchanging data and addresses in a dual port RAM.

13. Method for connecting contour elements from image data by means of at least one pipelined processor device, the method comprising:
in a first process, generating and storing in a memory a list of coordinates of the starting points and endpoints of chains,
and, in a second process, for each starting point and endpoint, searching the list of coordinates of starting points and endpoints for the last occurrence of the same coordinate or coordinates lying within a neighborhood of a specified size,
and, in a third process, to each starting point or endpoint, allocating a vertex index and an instance index, wherein the vertex index is a running index of the vertices and the instance index represents a running index of the starting points and endpoints belonging to a vertex, and wherein associated points from the set of starting points and endpoints receive the same vertex index and wherein associated points are those points from the set of starting points and endpoints that have the same coordinates or coordinates lying within a neighborhood of a specified size.

14. Method according to claim 13, wherein chains are fed to the first process continuously and the first, second, and third processes are carried out simultaneously.

15. Method according to claim 13, characterized in that at least one bit is allocated and stored for distinguishing a starting point from an endpoint.
